(19) United States
(12) Patent Application Publication
(10) Pub. No.: US 2011/0065404 A1
(43) Pub. Date: Mar. 17, 2011

(54) PORTABLE RADIO

(75) Inventors: Hideki Hayama, Kanagawa (JP); Hiroyuki Uejima, Miyagi (JP); Yukari Yamazaki, Miyagi (JP)

(73) Assignee: PANASONIC CORPORATION, Osaka (JP)

(21) Appl. No.: 12/992,234

(22) PCT Filed: Feb. 20, 2009
(86) PCT No.: PCT/JP2009/000752

§ 371 Date: Nov. 11, 2010

(30) Foreign Application Priority Data
May 12, 2008 (JP) 2008-124332

(51) Int. Cl. H04B 7/00; H01Q 1/24

(52) U.S. Cl. 455/278.1; 343/702

(57) ABSTRACT

There is provided a portable radio that enables simultaneous input of high frequency signals from a plurality of built-in antennas and performance of optimum receiving operation.

A portable radio 1 include a first built-in antenna 10A; a first low noise amplifier 122A that amplifies a signal from the first built-in antenna 10A; a first receiving section 124A that carries out a predetermined receiving operation to a signal from the first low noise amplifier 122A; a second built-in antenna 10B that is lower than the first built-in antenna 10A in terms of a gain; a second low noise amplifier 122B that amplifies a signal from the second built-in antenna 10B; a second receiving section 124B that carries out a predetermined receiving operation to a signal from the second low noise amplifier 122Bo; and a receiving circuit section 123 that carries out a predetermined diversity processing to the signals undergone receiving operation when both of the receiving sections 124 perform receiving operation.

### TECHNICAL FIELD

The present invention relates to a portable radio.

### BACKGROUND ART

A portable radio has recently become possible to receive a high frequency signal, such as a television broadcast, so as to enable watching of the television broadcast. A portable high frequency receiver hitherto known as such a portable radio has a high frequency signal input terminal for receiving a signal from an external antenna or a signal from a built-in antenna, and a changeover switch for switching the antennas in order to perform favorable receiving operation in an environment where a low signal level is acquired, such as an indoor receiving environment (see; for instance, Patent Document 1). The receiver can supply a broadcast signal, which has been supplied from a stationary antenna exhibiting superior receiving sensitivity and which has a high signal level, to the high frequency signal input terminal. Accordingly, even in a room where a low signal level is achieved by receiving operation of the built-in antenna, the receiver can properly receive a television broadcast.

The receiver also has a first amplifier and a second amplifier. When a signal input by way of the high frequency signal input terminal has a nature of causing a distortion in an amplifier, a control section deactivates the second amplifier according to a magnitude of power detected by a power detector. The amplifier can attenuate the input signal, and a distortion characteristic which arises when a signal having a high input level is received becomes better, so that distortion of the signal is lessened.

Patent Document 1: Japanese Patent No. 3891183

### DISCLOSURE OF THE INVENTION

### Problem that the Invention is to Solve

However, in a portable radio, an emphasis is placed on a design feature and two built-in antennas are likely to be provided for the design requirements. Therefore, an antenna gain of such a portable radio becomes smaller when two built-in antennas are provided than the antenna gain of a device using an outwardly projecting whip antenna or an external antenna. The technique described in connection with Patent Document 1 is intended to receive an input of only a high frequency signal from any one of a built-in antenna and an external antenna and not to simultaneously receive inputs of signals from both antennas. Further, even when there are two built-in antennas, if a low noise amplifier, or the like, is inserted in order to compensate for a decrease in a gain of the built-in antenna, it will sometimes become impossible to perform desired receiving operation at the time of an input of a high intensity electric field in which signal intensity of a signal input to a low noise amplifier is a predetermined level or more.

The present invention has been conceived in view of the circumstances of the related art and aims at providing a portable radio that enables simultaneous input of high frequency signals from a plurality of built-in antennas and performance of optimum receiving operation.

### Means for Solving the Problem

A portable radio of the present invention includes a first built-in antenna that receives a high frequency signal; a first low noise amplifier that amplifies a signal from the first built-in antenna; a first receiving section that carries out a predetermined receiving operation to a signal from the first low noise amplifier; a second built-in antenna that receives a high frequency signal and that is lower than the first built-in antenna in terms of a gain; a second low noise amplifier that amplifies a signal from the second built-in antenna; a second receiving section that carries out a predetermined receiving operation to a signal from the second low noise amplifier; and a receiving circuit section that performs a predetermined diversity processing by using the signal underwent receiving operation in the first receiving section and the signal underwent receiving operation in the second receiving section when the first receiving section and the second receiving section have performed receiving operation.

The configuration makes it possible to place an emphasis on a design of a portable radio, to simultaneously input high frequency signals from a plurality of built-in antennas, and to perform optimum receiving operation.

In the portable radio of the present invention, the first built-in antenna and the second built-in antenna receive television signals.

The configuration makes it possible to receive television signals from the two antennas, to perform optimum receiving operation, and to watch a television broadcast with high image quality and high sound quality.

The portable radio of the present invention further includes a signal combination section that combines a signal output from the first receiving section with a signal output from the second receiving section; and a receipt control section that determines whether or not to perform the receiving operation by use of the first receiving section and the receiving operation by use of the second receiving section, on the basis of a BER (Bit Error Rate) value of the combinational signal calculated by the signal combination section, a C/N (Carrier to Noise Ratio) of the receiving operation calculated by the first receiving section, and a C/N ratio of the receiving operation calculated by the second receiving section.

By means of the configuration, it is determined whether or not the respective receiving systems perform the receiving operation (tuning processing or demodulation processing), on the basis of a C/N ratio calculated from a signal input to the first receiving section, the first receiving section, a C/N ratio calculated from a signal input to the second receiving section, and in addition a BER value output from the signal combination section where the two signals are combined together. Therefore, optimum receiving operation can be performed. It thereby becomes possible to watch; for instance, a television broadcast with high image quality and high sound quality.

In the portable radio of the present invention, when the BER value calculated by the signal combination section is smaller than a predetermined value and when a C/N ratio calculated by the first receiving section is smaller than a C/N ratio calculated by the second receiving section, the receipt control section performs control operation so as to halt receiving operation performed by the first receiving section and let the second receiving section perform receiving operation.

When received electric field is a comparatively high intensity electric field, the chance of a distortion arising in a signal output from the low noise amplifier in a receiving system including a high gain antenna becomes greater; hence, there is a high possibility of the C/N ratios and the BER value being deteriorated. However, in a receiving system including a low gain antenna, the chance of a signal output from the low noise amplifier having undergone desired amplifying operation is high, and therefore deterioration of the C/N ratios is little. For these reasons, by means of the aforementioned configuration, an error rate of receiving operation decreases, and generation of an optimum received signal becomes possible.

In the portable radio of the present invention, when the BER value calculated by the signal combination section is smaller than a predetermined value and when a C/N ratio calculated by the second receiving section is worse than a C/N ratio calculated by the first receiving section, the receipt control section performs control operation so as to let the first receiving section perform receiving operation and halts receiving operation performed by the second receiving section.

In the case of a middle electric field whose received electric field is approximately middle in magnitude, a receiving system including a high gain antenna and a receiving system including a low gain antenna can perform desired receiving operation. In this case, sufficient signal intensity can be acquired for a received signal by means of only receiving operation performed by any of the receiving systems. The configuration makes it possible to perform optimum receiving operation and lessen processing load on the portable radio.

In the portable radio of the present invention, when the BER value calculated by the signal combination section is larger than a predetermined value, the receipt control section performs control operation so as to let the first receiving section and the second receiving section perform receiving operations.

The above-described configuration can reduce error rate in a case where the receiving system including a high gain antenna and the receiving system including a low gain antenna, and signal intensity of signals input to receiving sections is not suffice. Because in the above-described configuration both of the receiving systems perform receiving operation and subject signals subjected to receiving operation to diversity processing An error rate of a signal generated through diversity processing can thereby be reduced.

In the portable radio of the present invention, the portable radio has a first circuit board placed in a first enclosure and a second circuit board placed in a second enclosure; the first built-in antenna is a dipole antenna including at least a portion of the first circuit board and a portion of the second circuit board; and the second built-in antenna is an antenna element placed in the first enclosure or the second enclosure.

By the configuration, the first built-in antenna is embodied as an enclosure dipole antenna made up of enclosures of the portable radio, and the second built-in antenna is embodied as an antenna element incorporated in the enclosures. It is thus possible to simultaneously input high frequency signals from a plurality of built-in antennas and perform optimum receiving operation.

In the portable radio of the present invention, the portable radio has a circuit board housed in an enclosure; and the first built-in antenna and the second built-in antenna are antenna elements placed at mutually-opposing positions with the circuit board interposed therebetween.

By means of the configuration, the first built-in antenna is embodied as an antenna element incorporated in the enclosures, and the second built-in antenna is embodied as an antenna element incorporated in the enclosures. It is possible to simultaneously input high frequency signals from a plurality of built-in antennas and perform optimum receiving operation. Moreover, since the two built-in antennas are placed at mutually-opposing locations with a circuit board sandwiched therebetween, electromagnetic field coupling between the antennas is reduced, and superior antenna gains can be assured.

### Advantage of the Invention

The present invention enables simultaneous input of high frequency signals from a plurality of built-in antennas and performance of optimum receiving operation.

### BRIEF DESCRIPTION OF THE DRAWINGS

FIG. 1 is a view showing an example configuration of a portable radio of a first embodiment of the present invention.

FIG. 2 is a view showing an example detailed configuration of a receiving circuit section of the portable radio of the embodiment of the present invention.

FIG. 3 is a view showing an example relationship between a received electric field and a BER value of the embodiment of the present invention.

FIG. 4 is a view showing an example configuration of a portable radio of a second embodiment of the present invention.

### DESCRIPTIONS OF THE REFERENCE NUMERALS AND SYMBOLS

1, 1B PORTABLE RADIO
10A, 10B BUILT-IN ANTENNA
102, 103 HINGE SECTIONS
104 LOWER ENCLOSURE
105 UPPER ENCLOSURE
106, 112 CIRCUIT BOARD
110, 111 FEED ELEMENT
121A FIRST FEED SECTION
121B SECOND FEED SECTION
122A FIRST LOW NOISE AMPLIFIER (LNA)
122B SECOND LOW NOISE AMPLIFIER (LNA)
123 RECEIVING CIRCUIT SECTION
124A FIRST RECEIVING SECTION
124B SECOND RECEIVING SECTION
125 RECEIVING CONTROL SECTION
126 SIGNAL COMBINATION SECTION

### BEST MODES FOR IMPLEMENTING THE INVENTION

Portable radios of embodiments of the present invention include; for instance, portable phone terminals, personal digital assistants (PDA), portable television receivers, and the like.

### First Embodiment

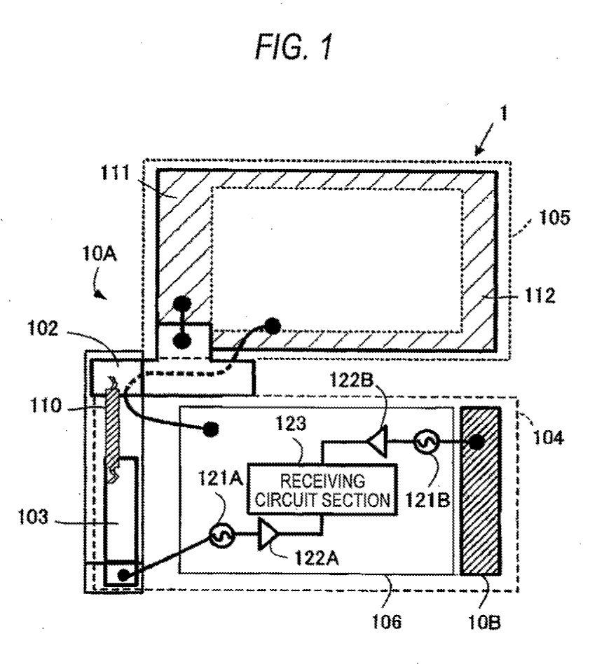

FIG. 1 is a view showing an example configuration of a portable radio 1 of a first embodiment of the present invention. The portable radio 1 shown in FIG. 1 has two enclosures; namely, an upper enclosure and a lower enclosure. The enclosures are re-closable in two directions; namely, a horizontal direction (a lateral direction) and a vertical direction (a longitudinal direction) by means of two hinge sections 102 and 103 made of a conductive member. FIG. 1 shows an example case where the portable radio is opened in the horizontal direction. A lower enclosure 104 is equipped with a circuit board 106, and an upper enclosure 105 is equipped with a circuit board 112. One end of a feed element (e.g., an antenna element) 110 provided in the lower enclosure 104 is electrically connected to the hinge section 103, and the other end of the same is electrically connected to the hinge section 102. An antenna element 111 provided in the upper enclosure 105 is electrically connected to the hinge section 102. The antenna element 111 is a metallic frame making up a portion of the upper enclosure 105. The feed element 110 and the hinge sections 102, 103 act as feed elements for feeding power to an upper-side element. The antenna element 111 is the upper-side element. Further, a ground pattern of the circuit board 106 of the lower enclosure 104 acts as a lower-side element. A dipole antenna includes the upper-side element and the lower-side element, and the overall enclosures are utilized as an antenna (an enclosure dipole antenna). As mentioned above, the enclosure dipole antenna is a built-in antenna 10A including at least a portion of a circuit board 112 placed in the upper enclosure 105 and a portion of the circuit board 106 placed in the lower enclosure 104.

Another built-in antenna 10B is disposed at a position opposite to the built-in antenna 10A with the circuit board 106 sandwiched therebetween. The built-in antenna 10B is a built-in antenna element accommodated in the lower enclosure 104 and is electrically connected to the circuit board 106. The built-in antenna 10B is lower than the built-in antenna 10A in terms of a gain. The built-in antenna 10B may also be either a dipole antenna or a monopole antenna.

The built-in antennas 10 (10A and 10B) are antennas for receiving a high frequency signal; for instance, a digital television signal ranging from 470 MHz to 770 MHz. The built-in antenna 10 may also act as a cellular antenna when a telephone function is used.

The circuit board 106 has a feed section 121 (a first feed section 121A and a second feed section 121B), an LNA (Low Noise Amplifier) 122 (a first LNA 122A and a second LNA 122B), and a receiving circuit section 123. The hinge section 103 is electrically connected to one end (an input end) of the feed section 121A. Further, the other end (an output end) of the feed section 121A is electrically connected to one end (an input end) of the LNA 122A. Moreover, the other end (an output end) of the LNA 122A is electrically connected to one end of the receiving circuit section 123. The built-in antenna 10B is electrically connected to one end (an input end) of the receiving circuit section 121B. Further, the other end (an output end) of the feed section 121B is electrically connected to one end (an input end) of the LNA 122B. Further, the other end (an output end) of the LNA 122B is connected to the other end of the receiving circuit section 123.

The feed section 121 is for feeding electric power to the built-in antenna 10. The feed section 121A feeds electric power to the built-in antenna 10A, and the feed section 121B feeds electric power to the built-in antenna 10B. The feed section 121A also exhibits a function as a matching section that matches an impedance of the feed section 121A of the upper-side element of the built-in antenna 10A to an input impedance of the LNA 122A. The feed section 121B also exhibits a function as a matching section that matches an impedance of the feed section 121B of the built-in antenna 10B to an input impedance of the LNA 122B.

The LNA 122 is for amplifying a high frequency signal from the built-in antenna 10; the LNA 122A amplifies a signal from the built-in antenna 10A; and the LNA 122B amplifies a signal from the built-in antenna 10B.

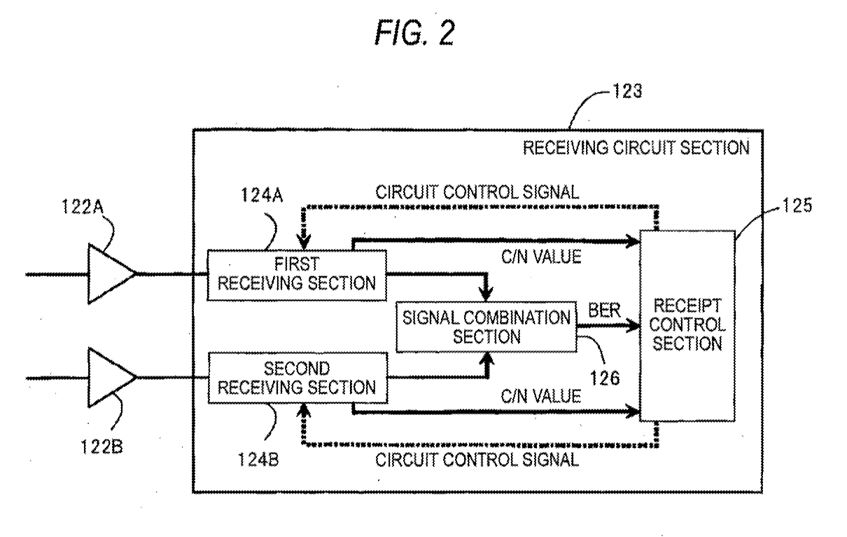

As can be seen from an example detailed configuration shown in FIG. 2, the receiving circuit section 123 has a first receiving section 124A, a second receiving section 124B, a receiving control section 125, and a signal combination section 126. FIG. 2 is a view showing an example detailed configuration of the receiving circuit section 123. One end (an input end) of the first receiving section 124A is electrically connected to the other end of the LNA 122A. Further, the other end of the first receiving section 124A is connected to one end (an input end) of the signal combination section. Moreover, one end (an output end) of the second receiving section 124B is electrically connected to the other end of the LNA 122B. The other end of the second receiving section 124B is connected to one end (another input end) of the signal combination section. Furthermore, one end (an output, end) of the signal combination section is connected to one end (an input end) of the receiving control section 125.

When predetermined conditions are fulfilled, the receiving sections 124 (124A and 124B) are operated by means of a circuit control signal that is sent from the receiving control section 125 to the receiving section and that will be described later, thereby performing operation for receiving a signal amplified by the LNA 122 (an amplified signal). Specifically, the receiving section 124A performs processing for receiving an amplified signal from the LNA 122A, and the receiving section 124B performs processing for receiving an amplified signal from the LNA 122B. During receiving operation, tuning processing for selecting; for instance, a signal having a frequency band used in a DTV, from amplified signals, there is performed demodulation processing for demodulating a signal having a frequency band selected through tuning processing, and the like.

Each of the receiving sections 124 calculates a C/N ratio (carrier-to-noise ratio) from a result of receiving operation. Specifically, the receiving section 124A calculates a C/N ratio from a result of processing for receiving an amplified signal input by the LNA 122A. Further, the receiving section 124B calculates a C/N ratio from a result of processing for receiving an amplified signal input by the LNA 122B. The term C/N ratio signifies a ratio of a carrier wave to noise in connection with a signal input by an LNA. The greater a numeral becomes, the better a receiving state.

The signal combination section 126 combines a signal from the receiving section 124A with a signal from the receiving section 124B and calculates a BER (Bit Error Rate) that is one of communication signal quality factors, from the resultant combinational signal.

The receiving control section 125 generates a circuit control signal from the BER value calculated by the signal combination section 126 and the C/N ratios calculated by the respective receiving sections 124 and transmits the circuit control signal to the receiving sections. The circuit control signal is a control signal for directing the receiving sections whether or not to stop operation.

It is determined whether or not the receiving sections 124 (124A and 124B) perform receiving operation, on the basis of the BER value calculated from the signal input to the signal combination section 126, the C/N ratio of the amplified signal input to the first receiving section 124A, and the C/N ratio of the amplified signal input to the second receiving section 124B.

When both the first receiving section 124A and the second receiving section 124B have performed receiving operation, the receiving circuit section 123 carries out a diversity processing to the signals subjected to receiving operation (received signals). During diversity processing, there is performed diversity combination processing during which received signals are brought in phase with each other and combined together, to thus generate a combinational signal and selective diversity processing during which C/N ratios of respective received signals are calculated and during which any one of the received signals is selected according to a calculation result.

An electrical path made by electrical connection of the built-in antenna 10A, the feed section 121A, the LNA 122A, and the first receiving section 124A is referred to as a first path, and an electrical path made by electrical connection of the built-in antenna 10B, the feed section 121B, the LNA 122B, and the second receiving section 124B is referred to as a second path.

Example operation of the receiving circuit section 123 and example operation of the receiving section 124 are now described.

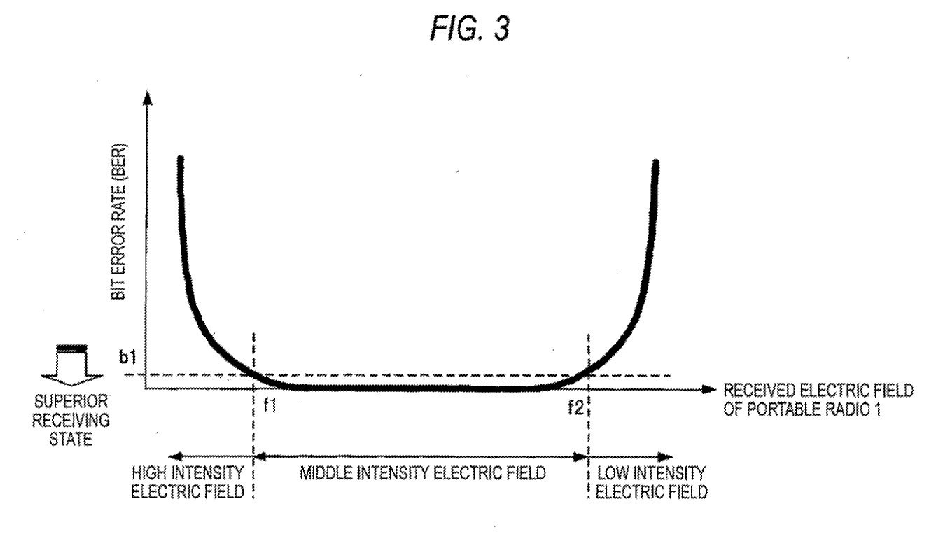

FIG. 3 shows a magnitude of a received electric field and a BER value achieved during receiving operation performed by the signal combination section 126. The received electric field means field intensity achieved at a location where the portable radio 1 is placed. The received electric field includes a high intensity electric field, an middle intensity electric field, and a low intensity electric field. The high intensity electric field designates a case of field intensity at which a BER value calculated by the signal combination section 126 comes to a predetermined value or more and at which the BER value is deteriorated (becomes larger) as the electric field becomes more intensive. The low intensity electric field designates a case of field intensity at which a BER value calculated by the signal combination section 126 comes to a predetermined value or more and at which the BER value is deteriorated as the electric field becomes less intensive. The middle intensity electric field designates a case of field intensity between the high intensity electric field and the low intensity electric field. According to a magnitude of the received electric field, operation (receiving operation, or the like) of the first receiving section 124A and operation of the second receiving section 124B change.

An explanation is now given to a case where a received electric field is a high intensity electric field.

When the received electric field achieved in the first path is a high intensity electric field; namely, when the received electric field is equal to a first predetermined value (f1 shown in FIG. 3) or more, the LNA 122A itself becomes distorted, or a signal amplified by the LNA 122A causes a distortion in the first receiving section. Therefore, when the received electric field is f1, the C/N ratio of the first receiving section 124A is superior. However, when the received electric field is f1 or more, an error in receiving operation performed by the first receiving section 124A becomes greater with an increase in the magnitude of the received electric field, so that the C/N ratio of the first receiving section 124A is deteriorated.

In the meantime, even when the received electric field achieved in the second path is a high intensity electric field; namely, even when the received electric field is a first predetermined value (f1 in FIG. 3) or more, a gain of the built-in antenna 10B is lower than a gain of the built-in antenna 10A; hence, the amplified signal output from the LNA 122B is subjected to normal amplification processing according to a high frequency signal. Therefore, when the received electric field is f1 and when the received electric field is greater than f1, an error hardly arises in receiving operation of the second receiving section 124B, and the C/N ratio of the second receiving section 124B comes to a superior (large) value.

Therefore, when the received electric field is a high intensity electric field, the C/N ratio achieved in the second path will be superior even if; for instance, the C/N ratio achieved in the first path is deteriorated. Therefore, the BER value calculated by the signal combination section 126 becomes small. However, in this case, in order to keep the BER value at a superior value, both the first receiving section 124A and the second receiving section 124B perform next receiving operation. The receiving circuit section 123 performs diversity processing, whereby a superior receiving characteristic is assured.

An explanation is next given to a case where the received electric field is a middle intensity electric field.

When the received electric field achieved in the first path is a middle intensity electric field; namely, when the received electric field is greater than a second predetermined value (f2 in FIG. 3) and no greater than the first predetermined value (f1 in FIG. 3), the amplified signals output from the LNA 122A and the LNA 122B are subjected to normal amplifying operation according to a high frequency signal. Therefore, the C/N ratio achieved by receiving operation of the first receiving section 124A comes to a superior value.

In the meantime, when the received electric field in the second path is a middle intensity electric field; namely, when the received electric field is greater than the second predetermined value (f2 in FIG. 3) and no greater than the first predetermined value (f1 in FIG. 3), an amplified signal output from the LNA 122B includes very few errors in receiving operation of the second receiving section 124B, and the amplified signal undergoes normal amplifying operation according to a high frequency signal. Therefore, the C/N ratio of receiving operation performed by the second receiving section 124B comes to a superior value.

As mentioned above, when the received electric field is a middle intensity electric field, the C/N ratio achieved in the first path and the C/N ratio achieved in the second path become superior, and the BER value calculated by the signal combination section 126 comes to a superior value. In this case, processing pertaining to the first path or processing pertaining to the second path is suffice. Therefore, either the first receiving section 124A or the second receiving section 124B (e.g., a receiving section exhibits a better C/N ratio) performs the next receiving operation, and the other receiving section does not perform the next receiving operation. Further, when the received electric field is a middle intensity electric field, calculation of the C/N ratio of the receiving section that does not perform the next receiving operation is not performed, either, and the operation of this receiving section may be halted. A processing load imposed on the portable radio 1 is thereby lessened.

An explanation is subsequently given to a case where the received electric field is a low intensity electric field.

When the received electric field achieved in the first path is a low intensity electric field; namely, when the received electric field is no greater than the second predetermined value (f2 in FIG. 3), the built-in antenna 10A normally receives a radio wave within around a level at which the received electric field assumes a value of f2. However, as the received electric field becomes smaller than f2, the chance of a failure to receive a radio wave becomes greater. For this reason, when the received electric field is f2, the BER value calculated by the signal combination section 126 is at about 0. However, when the received electric field is no greater than f2, an error in receiving operation of the first receiving section 124A increases as the magnitude of the received electric field becomes smaller, whereby the C/N ratio of the first receiving section 124A comes to a deteriorated value.

Likewise, when the received electric field achieved even in the second path is a low intensity electric field; namely, when the received electric field is no greater than the second predetermined value (f2 in FIG. 3), the built-in antenna 10A normally receives a radio wave when the received electric field is at about f2. However, the chance of a failure to receive a radio wave becomes greater as the received electric field becomes smaller than f2. Therefore, when the received electric field is f2, the BER value calculated by the signal combination section 126 is at about 0. However, when the received electric field is no greater than f2, an error in receiving operation of the second receiving section 124B increases as the magnitude of the received electric field becomes smaller, so that the C/N ratio of the second receiving section 124B comes to a deteriorated value.

Therefore, when the received electric field is a low intensity electric field, the C/N ratio of the first path and the C/N ratio of the second path become deteriorated values (smaller values) as the received electric filed becomes smaller, and hence the BER value becomes greater. For this reason, both the first receiving section 124A and the second receiving section 124B perform the next receiving operation. As a result of the receiving circuit section 123 performing diversity processing, a superior receiving characteristic is assured.

Next, an explanation is given to timing at which receiving operations of the respective receiving sections 124 are switched (a start of receiving operation or an end of receiving operation). Switching between the receiving operations is based on a BER value for previous receiving operation calculated by the signal combination section 126. When the BER value has become worse than the predetermined value, the receiving control section 125 activates both the first receiving section and the second receiving section. In the meantime, when the BER value is a predetermined value or less, each of the first receiving section and the second receiving section measures the C/N ratio, and the receiving control section 125 compares the thus-measured C/N ratios with each other. By reference to a comparison result, only the receiving section that provided a superior measured C/N ratio is activated from the next operation.

When the received electric field changes from the high intensity electric field to the middle intensity electric field; namely, the BER value calculated by the signal combination section 126 is determined to have changed from a value that is greater than the predetermined BER value (b1 in FIG. 3) to a value that is no greater than the predetermined BER value (b1 in FIG. 3), the receiving control section 125 compares the C/N ratio of the first receiving section 124A with the C/N ratio of the second receiving section 124B, whereupon the receiving operation of the receiving section that exhibits a worse C/N ratio ends. In the meantime, when the electric field changes from the middle intensity electric field to the high intensity electric field; namely, when the BER value calculated by the signal combination section 126 is determined to have changed from the value that is no greater than the predetermined BER value to a value that is greater than the predetermined BER value, the receiving control section 125 starts receiving operation of the first receiving section 124A and receiving operation of the second receiving section 124B.

Further, when the electric field changes from the low intensity electric field to the middle intensity electric field; namely, when the BER value calculated by the signal combination section 126 is determined to have changed from a value that is greater than the predetermined BER value (b1 in FIG. 3) to a value that is no greater than the predetermined BER value (b1 in FIG. 3), the receiving control section 125 compares the C/N ratio of the first receiving section 124A with the C/N ratio of the second receiving section 124B, whereupon receiving operation of the receiving section that exhibits a worse C/N ratio ends. In the meantime, when the electric field changes from the middle intensity electric field to the low intensity electric field; namely, when the BER value calculated by the signal combination section 126 is determined to have changed from a value that is no greater than the predetermined BER value to a value that is greater than the predetermined BER value, the receiving control section 125 starts receiving operation of the first receiving section 124A and receiving operation of the second receiving section 124B.

Such a portable radio 1 allows simultaneous input of high frequency signals from the plurality of built-in antennas 10A and 10B, thereby performing optimum receiving operation.

### Second Embodiment

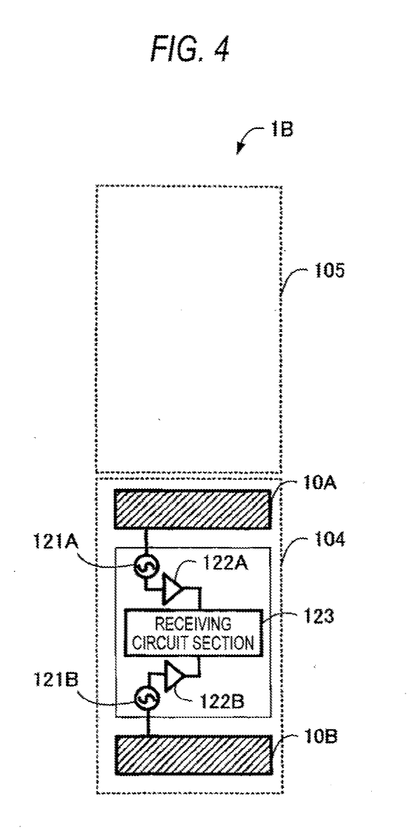

FIG. 4 is a view showing an example configuration of a portable radio of a second embodiment of the present invention. In a portable radio 1B shown in FIG. 4, the built-in antenna 10A is a built-in antenna element that operates as a monopole antenna or a dipole antenna. As in the case of FIG. 1, the built-in antenna 10B is a built-in antenna element that operates as a monopole antenna or a dipole antenna. The built-in antenna 10A and the built-in antenna 10B are placed at mutually-opposing positions with the circuit board 106 of the lower enclosure 104 sandwiched therebetween. An electrical connection between the first path including the built-in antenna 10A, the feed section 121A, the LNA 122A, and an un-illustrated first receiving section 124A included in the receiving circuit section 123 and the second path including the built-in antenna 10B, the feed section 121B, the LNA 122B, and an un-illustrated second receiving section 124B included in the receiving circuit section 123 is the same as that mentioned in connection with FIG. 1.

The feed section 121 feeds electric power to the built-in antennas 10. The feed section 121A feeds electric power to the built-in antenna 10A, and the feed section 121B feeds electric power to the built-in antenna 10B. Further, the feed section 121A also has a function of acting as a matching section that matches an impedance of the feed section 121A of the built-in antenna 10A to an input impedance of the LNA 122A. The feed section 121B also has a function of acting as a matching section that matches an impedance of the feed section 121B of the built-in antenna 10B to an input impedance of the LNA 122B. The portable radio is the same as that of the portable radio described in connection with the first embodiment in terms of operations of the constituent elements other than the feed sections.

Such a portable radio 1B enables simultaneous input of high frequency signals from the plurality of built-in antennas 10A and 10B and performance of optimum receiving operation.

The present invention has been described in detail by reference to the specific embodiments. However, it is manifest to persons who are versed in the art that the present invention be susceptible to various alterations or modifications without departing the spirit and scope of the invention.

The present patent application is based on Japanese Patent Application No. 2008-124332 filed on May 12, 2008 in Japan, the entire subject matter of which is incorporated herein by reference.

### INDUSTRIAL APPLICABILITY

The present invention is useful for a portable radio, or the like, that enables simultaneous input of high frequency signals from a plurality of built-in antennas and performance of optimum receiving operation.

1. A portable radio, comprising:
a first built-in antenna that receives a high frequency signal;
a first low noise amplifier that amplifies a signal from the first built-in antenna;
a first receiving section that carries out a predetermined receiving operation to a signal from the first low noise amplifier;
a second built-in antenna that receives a high frequency signal and that has a lower gain than that of the first built-in antenna;
a second low noise amplifier that amplifies a signal from the second built-in antenna;
a second receiving section that performs a predetermined receiving operation to a signal from the second low noise amplifier to; and
a receiving circuit section that carries out a predetermined diversity processing by using the signal underwent receiving operation in the first receiving section and the signal underwent receiving operation in the second receiving section when the first receiving section and the second receiving section have performed receiving operation.

2. The portable radio according to claim 1, wherein the first built-in antenna and the second built-in antenna receive television signals.

3. The portable radio according to claim 1, further comprising:
a signal combination section that combines a signal output from the first receiving section with a signal output from the second receiving section; and
a receipt control section that determines whether or not to perform the receiving operation by the first receiving section and the receiving operation by the second receiving section, on the basis of a BER (Bit Error Rate) value of the combinational signal calculated by the signal combination section, a C/N (Carrier to Noise Ratio) of the receiving operation calculated by the first receiving section, and a C/N ratio of the receiving operation calculated by the second receiving section.

4. The portable radio according to claim 3, wherein, when the BER value calculated by the signal combination section is smaller than a predetermined value and when a C/N ratio calculated by the first receiving section is smaller than a C/N ratio calculated by the second receiving section, the receipt control section performs control operation so as to halt receiving operation performed by the first receiving section and let the second receiving section perform receiving operation.

5. The portable radio according to claim 3, wherein, when the BER value calculated by the signal combination section is smaller than a predetermined value and when a C/N ratio calculated by the second receiving section is worse than a C/N ratio calculated by the first receiving section, the receipt control section performs control operation so as to let the first receiving section perform receiving operation and halts receiving operation performed by the second receiving section.

6. The portable radio according to claim 3, wherein, when the BER value calculated by the signal combination section is larger than a predetermined value, the receipt control section performs control operation so as to let the first receiving section and the second receiving section perform receiving operations.

7. The portable radio according to claim 1, wherein the portable radio has a first circuit board placed in a first enclosure and a second circuit board placed in a second enclosure;
the first built-in antenna is a dipole antenna including at least a portion of the first circuit board and a portion of the second circuit board; and
the second built-in antenna is an antenna element placed in the first enclosure or the second enclosure.

8. The portable radio according to claim 1, wherein the portable radio has a circuit board housed in an enclosure; and
the first built-in antenna and the second built-in antenna are antenna elements placed at mutually-opposing positions with the circuit board interposed therebetween.
